(19) United States
(12) Patent Application Publication
(10) Pub. No.: US 2010/0279177 A1
(43) Pub. Date: Nov. 4, 2010

(54) Carbon fiber conductive sheet and manufacturing method thereof

(76) Inventor: Hsiharng Yang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,865

(22) Filed: Jan. 3, 2008

(51) Int. Cl. H01M 8/02; C01B 31/00; B32B 5/00; H05B 3/10

(52) U.S. Cl. 429/400; 264/29.7; 428/220; 219/553

(57) ABSTRACT

It discloses a carbon fiber conductive sheet and its manufacturing method. The manufacturing method includes the steps of (1) carding step, (2) hydro-entanglement processing step, (3) resin dipping step, (4) hot pressing step, (5) flattening step, (6) surface refining step, (7) first carbonization processing step, (8) second carbonization processing step, and (9) finishing step. By the special hydro-entanglement process, many horizontally disposed fibers are bent down to entangle with other fibers, so its thickness can be smaller than 250 μm. About this invention, the hydro-entanglement process makes the fibers evenly and well distributed. The hydro-entanglement process will not destroy the fiber material. It is possible to fabricate a carbon fiber conductive sheet thinner than 15 μm. In addition, this invention has a great electric conductivity between both sides of this sheet.

### BACKGROUND OF THE INVENTION

1. Field of the Invention

The present invention relates to a carbon fiber conductive sheet and a manufacturing method of carbon fiber conductive sheet. About this invention, the hydro-entanglement process makes the fibers evenly distributed. The hydro-entanglement process will not destroy the fiber material. It is possible to fabricate a carbon fiber conductive sheet thinner than 15 μm. In addition, this invention has a great electric conductivity between both sides of this sheet.

2. Description of the Prior Art

As shown in FIGS. 1 and 2, the manufacturing method of a conventional carbon fiber conductive sheet includes the following steps:

[1] needle punching step 91: as depicted schematically in FIG. 3, many metal needles 81 pressing into fibers 71 of the fiber material 70 so as to conduct a felting process;

[2] resin dipping step 92: placing the fiber material 70 to be dipped into resin;

[3] hot pressing step 93: conducting a hot pressing process to the fiber material 70 for hardening;

[4] carbonization processing step 94: heating the fiber material 70 (in a carbonization oven) for carbonization;

[5] finishing step 95: obtaining a carbon fiber conductive sheet (as illustrated in FIGS. 4 and 5, the carbonized fiber material 70 becomes the carbon fiber conductive sheet).

The conventional carbon fiber conductive sheet still has the following disadvantages or problems.

[1] After the needle punching process, the fibers are not evenly distributed. Referring to FIG. 3, many solid needles 81 press into the fiber material 70 (thickness of 300 μm) that is the needle punching processing. A second distance W2 (about 500 μm) that is defined as the distance between two neighboring needles 81. Each needle 81 has a second diameter D2 of approximately 200 μm. In addition, a single fiber 71 has a diameter of roughly 10 μm. Therefore, the needle 81 (having the diameter of 500 μm) is equal to the total width of fifty fibers arranged side by side. In view of a fiber 71, the needle 81 is relative large. Meanwhile, the distance between two neighboring needles 81 is relatively too large. The fibers 71 in the contacting zone (contacting with the needles 81) are tighter. But, the fibers 71 in the non-contacting zone will be quite loose. Thus, after such conventional needle punching processing step, the fibers 71 are not well distributed.

[2] The needle punching process is easy to destroy the fiber material. As illustrated in FIG. 4, the fiber material 70 has a first thickness T1 before conducting the needle punching process. After the needle punching process, some of the fibers will be entangled together (for increasing both the tensile strength and the electric conductivity between two sides of the sheet). However, the solid needle 81 (see FIG. 3) is quite possible to break or destroy the fiber material 70. It is easy to form some through holes 72. If such product is used as a gas diffusion layer (referring to the carbon fiber conductive sheet 20A in FIG. 6) of a typical fuel cell, the zone with more through holes 72 (as shown in FIG. 4) will cause more gas penetrating; whereas the zone with fewer through holes 72 will cause less gas penetrating. Therefore, the gas penetrating is not evenly distributed. The electro-chemical reactions will not occur evenly.

[3] The needles are easy to pierce through this thin fiber material sheet. Referring to FIG. 5, when the first thickness T1 decreases to the second thickness T2, these needles 81 will pierce through this fiber material 70 and then form some piercing holes 73. Particularly, once the second thickness is thinner than 20 μm, such piercing holes 73 are unavoidable.

[4] The electric conductivity between both sides of the sheet is poor. If the fibers 71 are not evenly distributed and the vertically disposed fibers 71 are fewer, the gas penetrating is not uniform and the electric conductivity between both sides of the sheet becomes poor.

### SUMMARY OF THE INVENTION

The primary object of the present invention is to provide a carbon fiber conductive sheet and manufacturing method thereof. In which, the hydro-entanglement process makes the fibers evenly and well distributed.

The other object of the present invention is to provide a carbon fiber conductive sheet and manufacturing method thereof. In which, the hydro-entanglement process will not destroy the fiber material.

The next object of the present invention is to provide a carbon fiber conductive sheet and manufacturing method thereof. It is possible to fabricate a carbon fiber conductive sheet thinner than 15 μm.

The other object of the present invention is to provide a carbon fiber conductive sheet and manufacturing method thereof. This invention has a great electric conductivity between both sides of this sheet.

### BRIEF DESCRIPTION OF THE DRAWINGS

FIG. 1 is a flow chart for producing the conventional carbon fiber conductive sheet.

FIG. 2 is a view illustrating a portion of the structure of the conventional one.

FIG. 3 is a view showing the needle punching process in the conventional method.

FIG. 4 shows one possible result after the needle punching process in the conventional method.

FIG. 5 shows another possible result after the needle punching process in the conventional method.

FIG. 6 is perspective view depicting the present invention applied in the field of fuel cell.

FIG. 7 is a flow chart of the manufacturing method of the present invention.

FIG. 8 a view illustrating the hydro-entanglement processing step of this invention.

FIGS. 9A and 9B are the enlarged views showing the processes in the hydro-entanglement process.

FIG. 10 is cross-sectional view of the final product of this invention.

FIG. 11 shows another application of this invention.

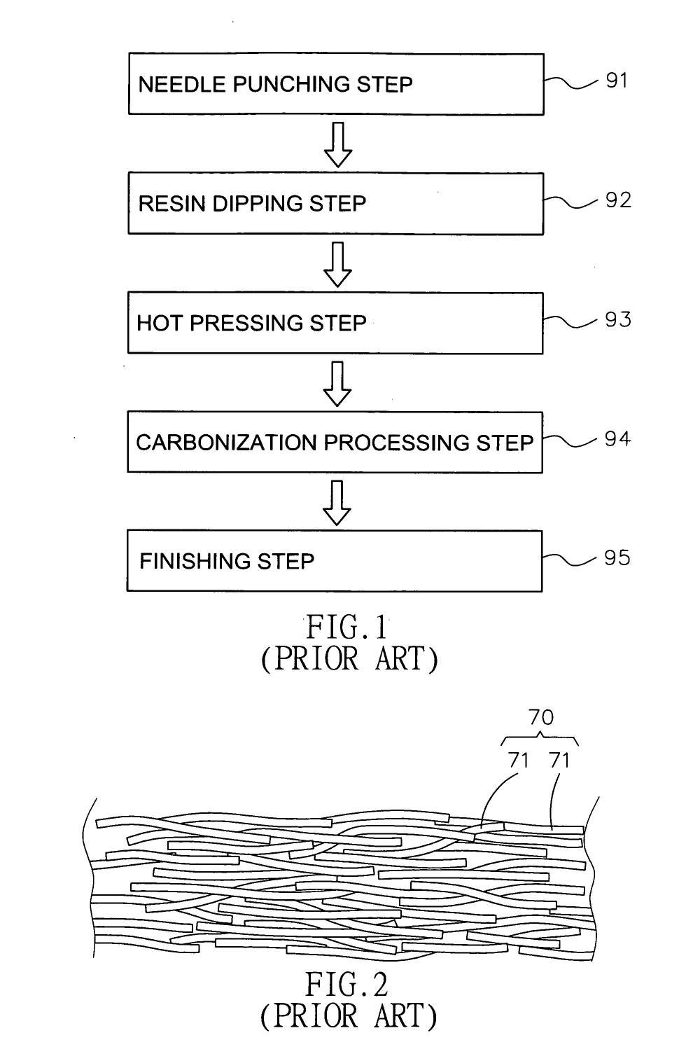

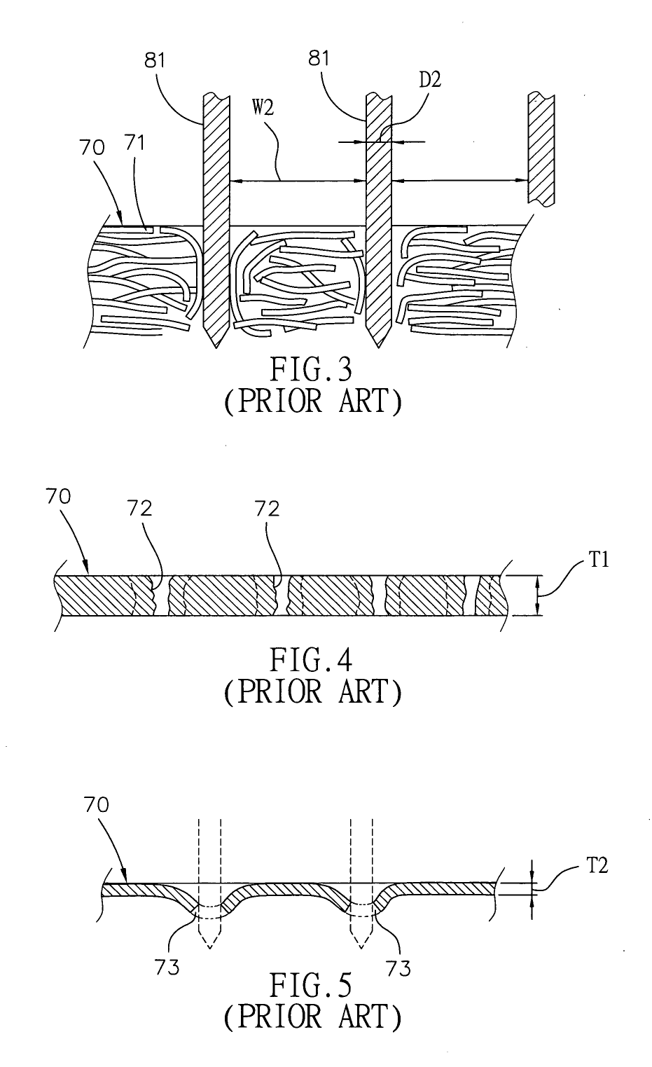

### DETAILED DESCRIPTION OF THE PREFERRED EMBODIMENT

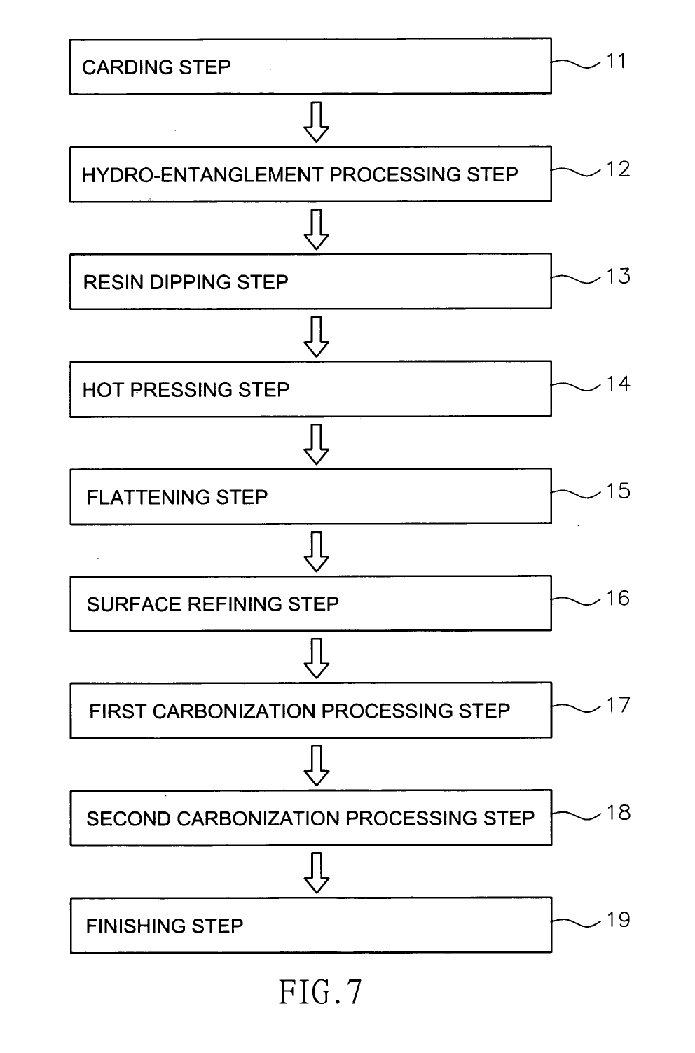

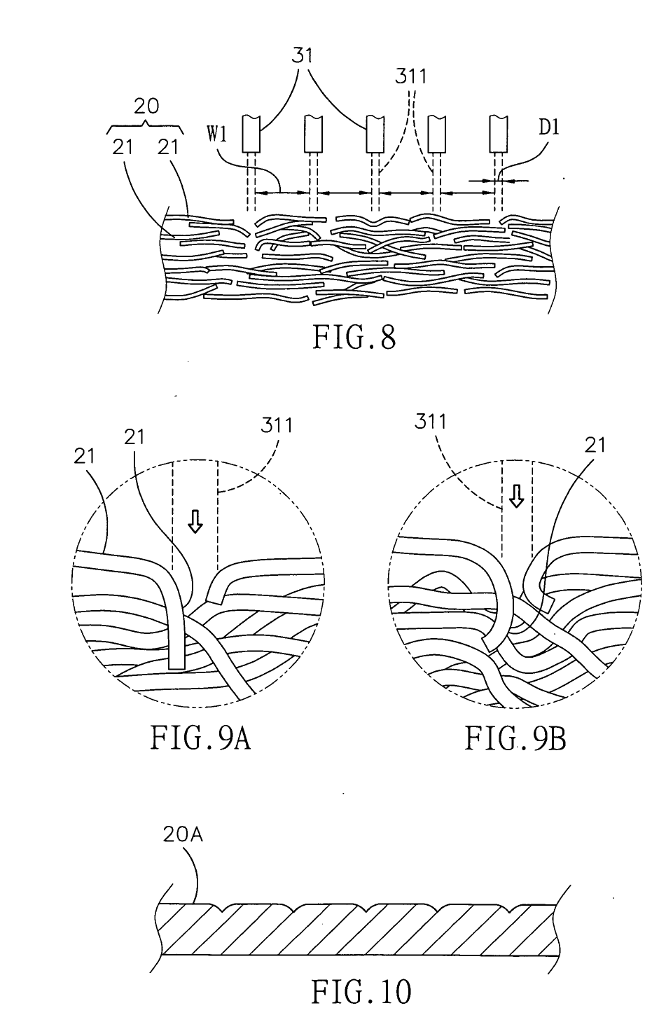

Referring to FIGS. 7 and 8, the present invention is a carbon fiber conductive sheet and its manufacturing method. With regard to the manufacturing method, it comprises the following steps.

[1] Carding step 11: it is to prepare a fiber material 20 containing a plurality of fibers 21 and then to conduct a carding process so that most fibers 21 are disposed substantially horizontally. Meanwhile, the cotton knots and foreign matters can be removed in this step.

[2] Hydro-entanglement (or called spunlace) processing step 12: it utilizes a plurality of hydro-entanglement nuzzles 31 to generate a plurality of micro water jets 311 on the fiber material 20 so as to evenly press on the fiber material 20 in order to form a thin film. In particular, a thickness of the fiber material 20 is possible to be presses down to approximately 15 μm or 10 μm. There is a gap (which is defined as a first distance W1) between two neighboring micro water jets 311. The first distance W1 is approximately between 100˜200 μm. Each micro water jet 31 has a diameter (defined as a jet diameter D1) approximately is 50 μm. Accordingly, some fibers 21 of the fiber material 20 are bent down vertically due to these strong micro water jets 311. It causes some fibers 21 to be entangled each other (as shown in FIG. 9A and FIG. 9B) as so to increase its tensile strength and porosity. Furthermore, it can decrease its electric resistance.

[3] Resin dipping step 13: it is to place the fiber material 20 to be dipped into a polymer resin.

[4] Hot pressing step 14: it is to conduct a hot pressing process to the fiber material 20.

[5] Flattening step 15: it is to conduct a flattening process for the fiber material 20;

[6] Surface refining step 16: it is to conduct a surface refining procedure for the fiber material 20;

[7] First carbonization processing step 17: it is to heat up the fiber material 20 to 950° C. to 1050° C. (in a carbonization oven) about a predetermined time for first carbonization and removing cruds. Probably, the cruds (which is roughly 30% of total weight) can be removed.

[8] Second carbonization processing step 18: it is to heat up this fiber material 20 to 1700° C. to 1900° C. about another predetermined time for second carbonization and increasing its purity.

[9] Finishing step 19: one can obtain a carbon fiber conductive sheet 20A (as shown in FIG. 10).

Concerning this carbon fiber conductive sheet 20A, it is a substantially pliant thin film consisted by fibers 21. During the hydro-entanglement process, some of the horizontal fibers 21 are bent down vertically so as to entangle with neighboring fibers (for increasing the electric conductivity between both sides of this sheet). After which, it will continue the related processes like resin dipping, flattening, surface refining and carbonization processing steps respectively. Finally, a pliant carbon fiber conductive sheet 20A thinner than 250 μm can be obtained.

Moreover, the carbon fiber conductive sheet 20A is consisted by many fibers. After the hydro-entanglement process (or called spunlace), these fibers will be bent down vertically as well as be evenly tangled each other. Hence, it can increase its tensile strength and decrease it electric resistance.

This invention can be made as a roll (by mass production) and then to be cut into smaller pieces so that it can be used in the gas diffusion layer of the fuel cell or in other fields.

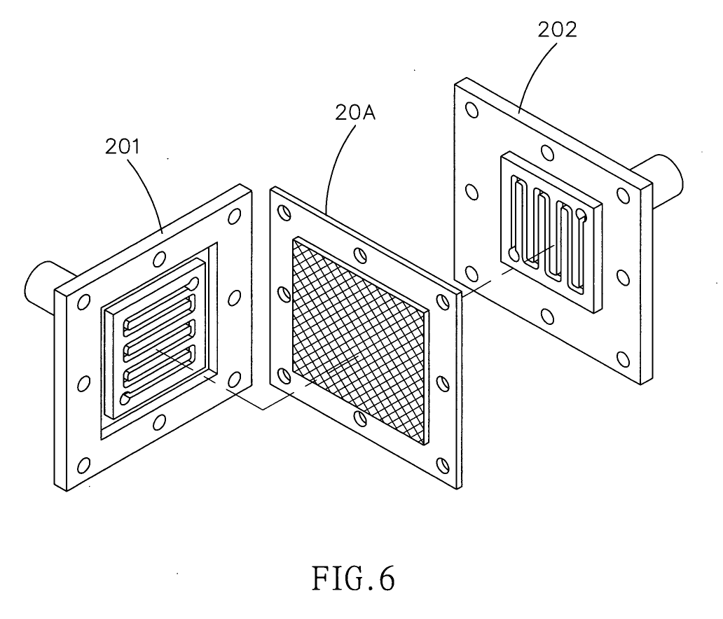

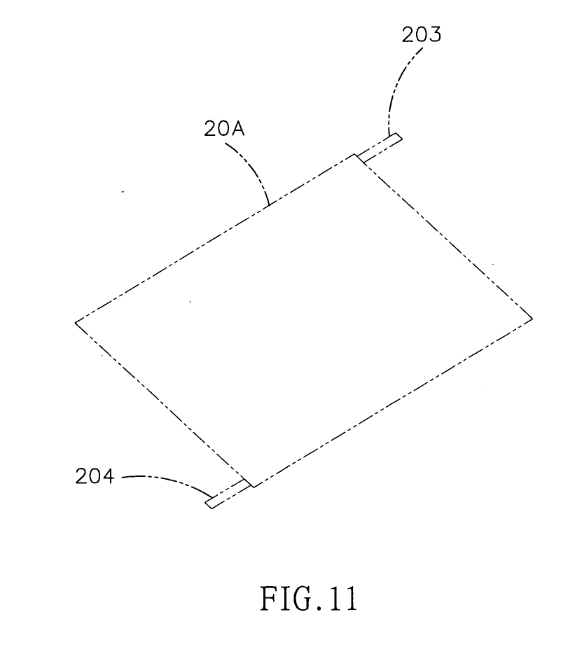

This invention can be applied at least in the following fields.

[a] It is a gas diffusion layer of a fuel cell. As shown in FIG. 6, the carbon fiber conductive sheet 20A (as a gas diffusion layer) is combined with a pair of a first bipolar plate 201 and a second bipolar plate 202 so as to form a fuel cell.

[b] It is a material with high conductivity and anti electromagnetic wave radiation property. Since this invention has an excellent electric conductivity, it can be used as a material with high conductivity and anti electromagnetic wave radiation property.

[c] It becomes a thin-film heater. As illustrated in FIG. 11, this invention can further comprise a first electrode 203 and a second electrode 204 disposed on both sides of the carbon fiber conductive sheet 20A to form a thin-film heater. By applying sufficient electricity between the first electrode 203 and the second electrode 204, this carbon fiber conductive sheet 20A can generate heat.

[d] It can be used as a carbon conductive sheet that needs high porosity.

[e] It can be applied in the product that needs great wear resistance. Of course, this invention also can be applied in other field that need a conductive electrode.

The advantages and functions of the present invention can be summarized as follows.

[1] The hydro-entanglement treatment makes the fibers evenly distributed. This invention utilizes many micro water jets to conduct the hydro-entanglement process (or called spunlace). So, more entanglements among fibers will increase its tensile strength with excellent distribution and porosity.

[2] The hydro-entanglement treatment will not destroy the fiber material. Because water is a fluid that is flowable, the possibility to destroy the horizontal, vertical or tangled fibers is low.

[3] It is possible to fabricate a carbon fiber conductive sheet thinner than 15 μm. Since this invention uses the hydro-entanglement process, it is possible to fabricate a carbon fiber conductive sheet thinner than 15 μm.

[4] This invention has a great electric conductivity between both sides of this sheet. The hydro-entanglement process makes the fibers more compact and tighter. Hence, its tensile strength is good. The fibers are evenly distributed with excellent porosity and great electric conductivity. This sheet can be wrapped as a roll for easier and cheaper storage or transportation.

The above embodiments are only used to illustrate the present invention, not intended to limit the scope thereof. Many modifications of the above embodiments can be made without departing from the spirit of the present invention.

1. A manufacturing method of carbon fiber conductive sheet comprising:
[1] carding step: preparing a fiber material containing a plurality of fibers, conducting a carding process for said fiber material so that most fibers are disposed substantially horizontally;
[2] hydro-entanglement processing step: by utilizing a plurality of hydro-entanglement nuzzles to generate a plurality of micro water jets on said fiber material so as to evenly press on said fiber material to form a thin film; some fibers of said fiber material being bent down vertically by said micro water jets and causing fibers to be entangled each other as so to increase its tensile strength and porosity and to decrease it electric resistance;
[3] resin dipping step: placing said fiber material to be dipped into resin;
[4] hot pressing step: conducting a hot pressing process to said fiber material;
[5] flattening step: conducting a flattening processing for said fiber material;
[6] surface refining step: conducting a surface refining procedure for said fiber material;
[7] first carbonization step: heating said fiber material to 950° C. to 1050° C. about a predetermined time for first carbonization and removing cruds;
[8] second carbonization step: heating said fiber material to 1700° C. to 1900° C. about another predetermined time for second carbonization and increasing its purity; and [9] finishing step: obtaining a carbon fiber conductive sheet.

2. The manufacturing method of carbon fiber conductive sheet as claimed in claim 1, wherein a gap between two neighboring micro water jets is approximately between 100˜200 μm and each micro water jet has a diameter approximately being 50 μm during said hydro-entanglement processing step.

3. The manufacturing method of carbon fiber conductive sheet as claimed in claim 2, wherein said hydro-entanglement nuzzles generating micro water jets to press on said fiber material with a thickness of approximately 10 μm.

4. A carbon fiber conductive sheet comprising:
a carbon fiber conductive sheet which is a substantially pliant thin film consisted by fibers; some of said horizontal fibers being entangled by a hydro-entanglement processing step to be bent down vertically so as to entangle with neighboring fibers; and then being processed by a resin dipping, flattening, surface refining and carbonization processing steps to form a pliant carbon fiber conductive sheet having a thickness less than 250 μm.

5. The carbon fiber conductive sheet as claimed in claim 4, wherein said thickness of said carbon fiber conductive sheet thinner than 50 μm.

6. The carbon fiber conductive sheet as claimed in claim 4, further comprising a pair of bipolar plates to form a fuel cell.

7. The carbon fiber conductive sheet as claimed in claim 4, further comprising a first electrode and a second electrode disposed on both sides of said carbon fiber conductive sheet to form a thin-film heater.
